(19) United States
(12) Patent Application Publication
(10) Pub. No.: US 2025/0331966 A1
(43) Pub. Date: Oct. 30, 2025

(54) TOOL-FREE QUICK-RELEASE CLAMPING HOLDER

(71) Applicant: Ivoclar Vivadent AG, Schaan (LI)

(72) Inventors: Patrick MEIER, Ludesch (AT); Andreas HABIT, Tschagguns (AT); Andreas GANTIOLER, Bludenz (AT)

(21) Appl. No.: 19/191,294

(22) Filed: Apr. 28, 2025

(30) Foreign Application Priority Data
Apr. 29, 2024 (EP) 24172979.7

(51) Int. Cl. A61C 13/00; B25B 5/06; B25B 5/10

(52) U.S. Cl. CPC A61C 13/0027; B25B 5/061; B25B 5/10

(57) ABSTRACT

A clamping holder (100) for a dental blank (103), having a first holder part (105-1) for inserting the dental blank (103); a second holder part (105-2) which is connected or can be coupled to the first holder part (105-1); a clamping device (125) for exerting a clamping force on the dental blank (103) between the first holder part (105-1) and the second holder part (105-2); and a pneumatic element (107-1, . . . , 107-4) for releasing or generating the clamping force.

### CROSS-REFERENCE TO RELATED APPLICATIONS

This application claims priority to European Patent Application No. 24172979.7 filed on Apr. 29, 2024, the disclosure of which is incorporated herein by reference in its entirety.

### TECHNICAL FIELD

The present invention relates to a clamping holder for a dental blank and a method of clamping a dental blank.

US20180236620, 20230083917 and 20220192802 are directed to milling machines and holders and are hereby incorporated by reference in their entirety.

### SUMMARY

It is the technical task of the present invention to accelerate and simplify the clamping of a dental blank in a processing machine.

This task is solved by subject-matter according to the independent claims. Advantageous embodiments are the subject-matter of the dependent claims, the description and the figures.

According to a first aspect, the present task is solved by a clamping holder for a dental blank, comprising a first holder part for inserting the dental blank; a second holder part for the dental blank which is connected or can be coupled to the first holder part; a clamping device for exerting a clamping force on the dental blank between the first holder part and the second holder part; and a pneumatic element for releasing or generating the clamping force. The clamping holder clamps the dental blank between the first holder part and the second holder part by means of a clamping force and holds it in position. The automatically operable pneumatic element achieves the technical advantage that this clamping force can be compensated by air pressure so that the first or second holder part can then be coupled to or released from the other holder part. Clamping and releasing the dental blank can then be carried out without tools. This considerably accelerates clamping and releasing the dental blank in the clamping holder.

In a technically advantageous embodiment of the clamping holder, the clamping device comprises a spring. This achieves the technical advantage, for example, that the dental blank can be easily clamped between the first and second holder parts.

In another technically advantageous embodiment of the clamping holder, the spring applies the clamping force to a pneumatic piston. This achieves the technical advantage, for example, of a compact design. By using preloaded pistons, the clamping force can also be maintained without compressed air.

In another technically advantageous embodiment of the clamping holder, the clamping device comprises a spring behind the pneumatic piston. This achieves the technical advantage, for example, that the upper holder part can simply be released by the spring force and the dental blank can be easily removed. The clamping force between the holder parts is achieved by applying compressed air to the pneumatic piston.

In another technically advantageous embodiment of the clamping holder, the clamping device comprises a spring in front of the piston. This achieves the technical advantage, for example, of a compact design. By using preloaded pistons, the clamping force can also be maintained without compressed air and the final clamping is achieved by inserting a bolt through an opening at the bottom.

In another technically advantageous embodiment of the clamping holder, the pneumatic piston comprises a movable clamping element for coupling with the second holder part. The clamping element is, for example, a clamping pin with which a tensile force is transmitted from one holder element to the other holder element. This achieves the technical advantage, for example, that the holder parts can be coupled via the clamping element.

In another technically advantageous embodiment of the clamping holder, the pneumatic element is arranged inside the first or second holder part. This achieves the technical advantage, for example, that a compact and integral design is achieved and the pneumatic elements are protected against contamination in the milling area.

In another technically advantageous embodiment of the clamping holder, the pneumatic element comprises at least one pneumatic cylinder. The pneumatic cylinder can have a circular, oval or angular cross-section, for example quadrangular, hexagonal or octagonal. This achieves the technical advantage, for example, that the pneumatic element can be realized in a simple manner.

In another technically advantageous embodiment of the clamping holder, the clamping holder comprises several pneumatic elements. This achieves the technical advantage, for example, that a higher clamping force is achieved and the clamping force can be released uniformly.

In another technically advantageous embodiment of the clamping holder, the pneumatic elements are distributed around a recess for inserting the dental blank. This achieves the technical advantage, for example, that a uniform release of the dental blank is achieved.

In another technically advantageous embodiment of the clamping holder, the pneumatic elements are connected to one another by a common air duct. This achieves the technical advantage, for example, that the pneumatic elements can be actuated together.

In another technically advantageous embodiment of the clamping holder, the first holder part or the second holder part for the dental blank is connected or can be coupled to the first holder part or to the second holder part by a rotary movement or a latching movement. This achieves the technical advantage, for example, that the dental blank can be clamped quickly and easily.

In another technically advantageous embodiment of the clamping holder, the clamping holder comprises a compressed air connection which is integrated in a mechanical interface for fastening the clamping holder to a processing machine, or a compressed air connection for an external supply of compressed air. The compressed air connection can be used to supply the first and/or second holder part with compressed air. This achieves the technical advantage, for example, that the compressed air connection can be made at the same time as the clamping holder is attached to a manufacturing machine. In this case, the dental blank can also be clamped or released in the clamping holder using an external compressed air device via the compressed air connection. The clamping holder is then fixed together with the dental blank in the manufacturing device or removed from the manufacturing device.

According to a second aspect, the present task is solved by a clamping holder for a dental blank, comprising a first holder part for inserting the dental blank; a second holder part for the dental blank which is connected or can be coupled to the first holder part; a clamping device for exerting a clamping force on the dental blank between the first holder part and the second holder part; and a release element for releasing the clamping force. The release element is any automatically operable element with which the clamping force of the clamping device can be released. The release element can be operated electrically, pneumatically, mechanically or in another way. Otherwise, the clamping holder according to the second aspect can be configured in the same way as the clamping holder according to the first aspect. The clamping holder achieves the same technical advantages as the clamping holder according to the first aspect.

In a technically advantageous embodiment of the clamping holder, the clamping holder comprises several release elements for releasing the clamping force. This achieves the technical advantage, for example, that the clamping force can be released at several points.

In another technically advantageous embodiment of the clamping holder, the release elements are distributed around a recess for inserting the dental blank. This achieves the technical advantage, for example, that the clamping force can be released uniformly.

In another technically advantageous embodiment of the clamping holder, the release elements can be actuated individually or together. This achieves the technical advantage, for example, that the clamping force can be released efficiently.

In another technically advantageous embodiment of the clamping holder, the clamping holder comprises an interface for supplying energy to the release element, which is integrated in a mechanical interface for attaching the clamping holder to a processing machine or external device. This achieves the technical advantage, for example, that a simultaneous coupling of the release element is achieved when attaching the clamping holder.

According to a third aspect, the present task is solved by a method of clamping a dental blank, comprising the steps of inserting the dental blank into a first holder part; coupling the first holder part with a second holder part for the dental blank; exerting a clamping force on the dental blank between the first holder part and the second holder part; and releasing the clamping force by a release element. The method achieves the same technical advantages as the clamping holder according to the first aspect.

In a technically advantageous embodiment of the method, the dental blank is clamped between the first holder part and the second holder part by means of the clamping force. This achieves the technical advantage, for example, that the dental blank can be clamped in a simple manner.

In another technically advantageous embodiment of the method, the compressed air is supplied to several pneumatic elements via a common air duct. This achieves the technical advantage, for example, that the pneumatic elements can be actuated together. This makes it possible to couple or release the first and second holder parts.

In another technically advantageous embodiment of the method, the release elements are actuated via an external device which is arranged outside a manufacturing device. This achieves the technical advantage, for example, that the dental blank can also be inserted outside the manufacturing device and the clamping holder can be inserted into the manufacturing device together with the dental blank.

### BRIEF DESCRIPTION OF THE DRAWINGS

Exemplary embodiments of the invention are shown in the drawings and are described in more detail below, in which:

FIG. 1 shows a perspective view of a clamping holder for a dental blank;

FIG. 2 shows a further perspective view of the clamping holder for the dental blank in the decoupled state;

FIG. 3 shows a top view of the clamping holder for the dental blank;

FIG. 4 shows a lateral cross-sectional view of the clamping holder for the dental blank;

FIG. 5 shows a lateral enlarged cross-sectional view of the clamping element;

FIG. 6 shows a cross-sectional view of the clamping holder for the dental blank from above;

FIG. 7 shows a side view of the clamping holder for the dental blank; and

FIG. 8 shows a mechanical design of the clamping holder; and

FIG. 9 shows a block diagram of a method for clamping the dental blank.

### DETAILED DESCRIPTION

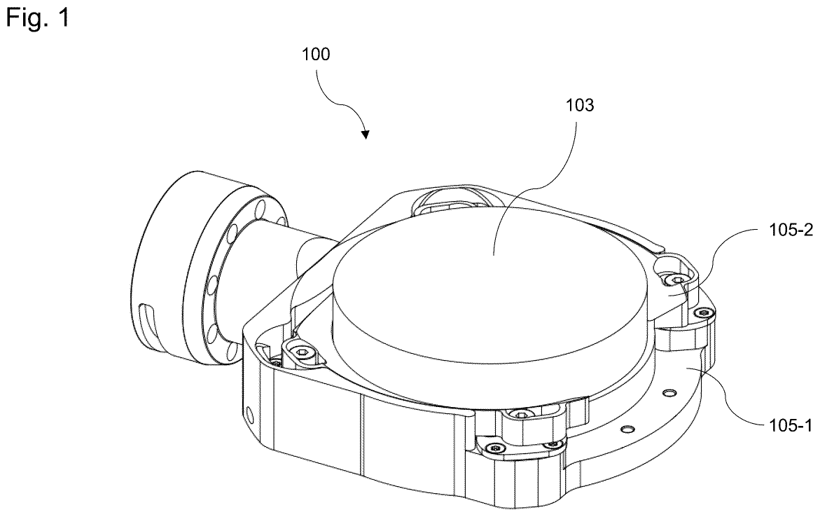

FIG. 1 shows a perspective view of a clamping holder 100 for a dental blank 103. The dental blank is formed, for example, by a round circular disk. However, 4- or 6-edged blanks are also conceivable. The dental blank 103 is formed, for example, from zirconium dioxide or another material. Various dental objects can be milled out of the dental blank 103 in a processing machine.

For this purpose, the dental blank 103 is clamped in the clamping holder 100 so that it can be held during manufacture and moved together with the clamping holder 100 in the processing machine. The clamping holder 100 comprises the two holder parts 105-1 and 105-2, which are made of metal, for example.

The dental blank 103 is held between the two holder parts 105-1 and 105-2 by means of a clamping force. The upper holder part 105-2 can be detached from the lower holder part 105-1 by means of a rotary movement. The lower holder part 105-1 comprises a recess in which the dental blank 103 lies.

The clamping holder 100 can also be configured in such a way that the first holder part 105-1 and the second holder part 105-2 can be moved away from each other by means of guide elements. Here, the guide elements also serve as clamping elements. In this case, the dental blank 103 can be inserted and clamped via the resulting gap between the first and second holder parts 105-1 and 105-2.

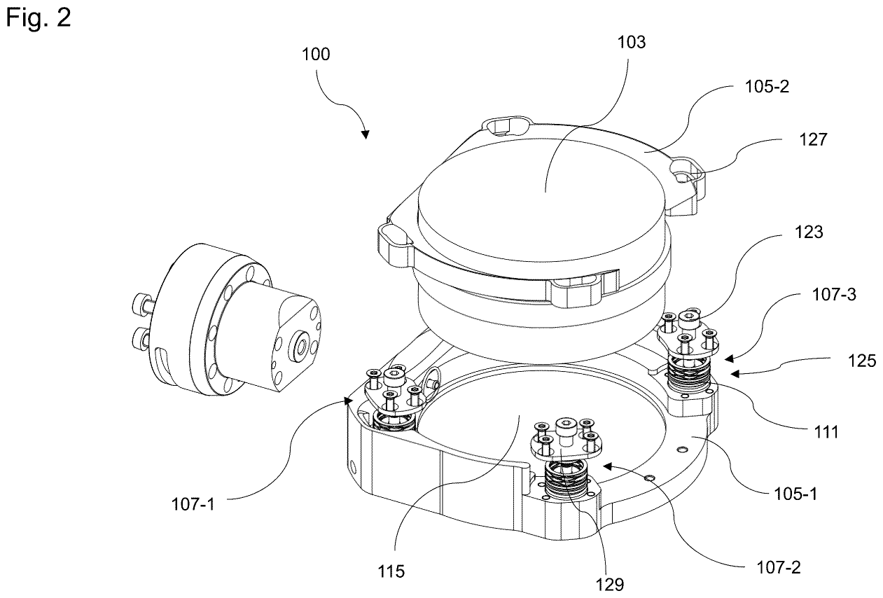

FIG. 2 shows a further perspective view of the clamping holder 100 for the dental blank 103 in the decoupled state of the holder parts 105-1 and 105-2. The first holder part 105-1 and the second, C-shaped holder part 105-2 are coupled via the movable clamping elements 123, into which the second holder part 105-2 can engage. The clamping elements 123 are inserted into coupling openings 127, which are formed in the second holder part 105-2. The two holder parts 105-1 and 105-2 can also be ring-shaped or have a closed frame.

In order to enable the coupling of the two holder parts 105-1 and 105-2, the movable clamping elements are first pressed outwards by means of the pneumatic pressure, thereby releasing the clamping force of the clamping elements. The holder part 105-2 is then rotated in order to achieve a stop, frictional and/or positive fit between the coupling openings 127 and the clamping elements 123. The geometry of the coupling openings 127 can be adapted for the positive fit. After coupling the two holder parts 105-1 and 105-2, the clamping force on the dental blank 103 can be maintained by means of the springs 111 via the clamping elements 123. A clamping device 125 for exerting a clamping force between the holder parts 105-1 and 105-2 is realized by the springs 111.

Several pneumatic elements 107-1, . . . , 107-3 are arranged as release elements around the recess 115 inside the first holder part 105-1. The pneumatic elements 107-1, . . . , 107-3 are drive devices in which compressed air is used as the working medium. The pneumatic elements 107-1, . . . , 107-3 each comprise a pneumatic cylinder 109, in which a movable pneumatic piston 113 is arranged. The springs 111 apply the clamping force to the pneumatic pistons. This clamping force is transmitted to the second holder part 105-2 via the movable clamping elements 123.

By using movable pneumatic pistons instead of screws, tool-free clamping of the dental blank 103 can be achieved. This results in a tool-free clamping system that can reliably clamp the material disks of the dental blanks 103.

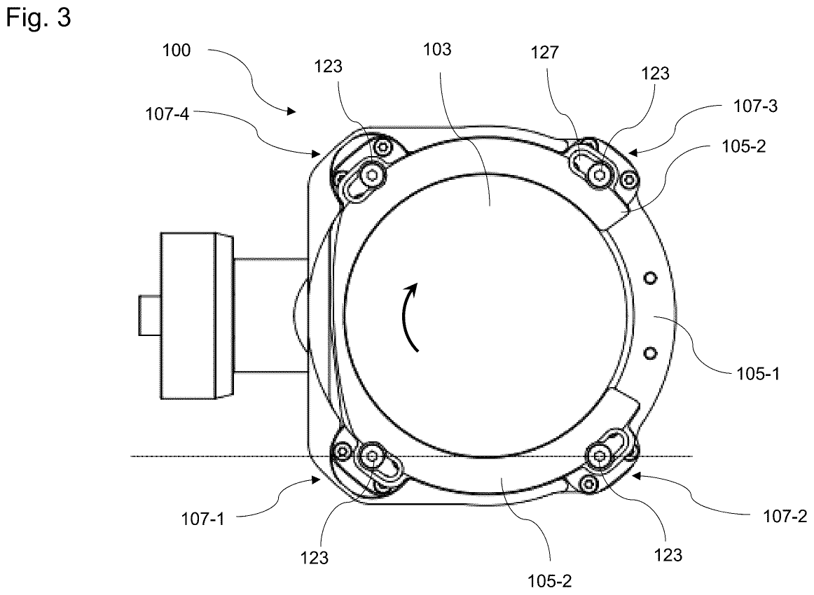

FIG. 3 shows a top view of the clamping holder 100. When inserting the dental blank 103, the second holder part 105-2 is first placed on the first holder part 105-1 in the position shown. The clamping elements 123 are inserted into the coupling openings 127. The second holder part 105-2 is then rotated in the direction of the arrow so that mechanical coupling with the clamping elements 123 takes place. In the process, a head of the clamping elements 123 slides over lateral projections arranged within the coupling openings 127.

Here, the clamping elements 123 are in a pushed-out position, which is brought about by the pneumatic elements 107-1, . . . , 107-4. For this purpose, the pneumatic elements 107-1, . . . , 107-4 are pressurized so that the pneumatic pistons with the clamping elements 123 move outwards and the rotary movement of the second holder part 105-2 is made possible.

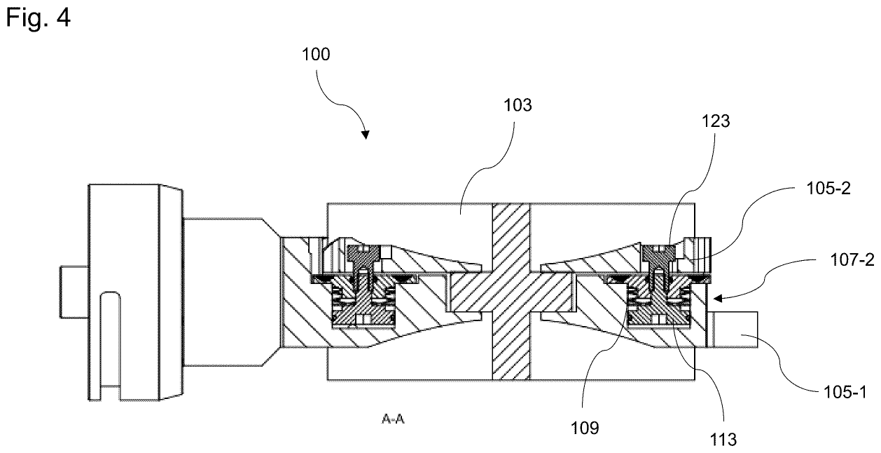

FIG. 4 shows a cross-sectional view of the clamping holder 100 for the dental blank 103. The outwardly projecting clamping elements 123 comprise an internal thread which is screwed onto an external thread of the pneumatic pistons 113. For this purpose, the clamping elements are inserted through an opening in the plate 129. The spring 111 is arranged around the pneumatic pistons 113, which presses the pneumatic piston 113 into the lower position within the pneumatic cylinder 109 and thus transmits the clamping force via the clamping element 123 to the upper holder part 105-2. The spring 111 ensures that this function can be implemented within the limited installation space. The cylindrical surfaces of the pneumatic cylinder 109 have a double seal in the area of the higher pressure in order to guarantee this function permanently.

If compressed air is fed into the pneumatic cylinder, the pneumatic piston 113 moves upwards so that the clamping force generated by the spring 111 is released and the holder part 105-2 can be released from the holder part 105-1 by means of a rotary movement. This results in a simple design of the pneumatic piston 113 and the holder parts 105-1 and 105-2.

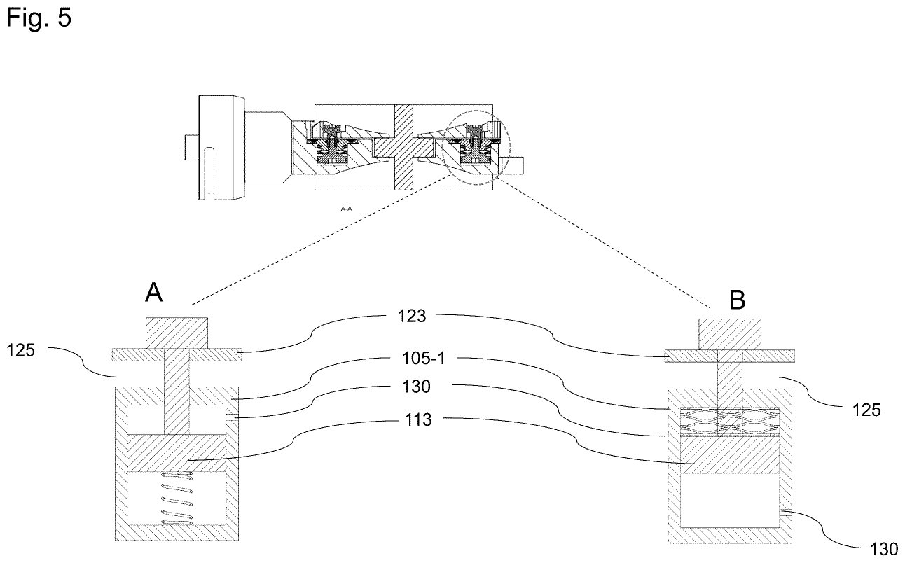

FIG. 5 shows a laterally enlarged cross-sectional view of the clamping element 123. In order to enable the coupling of the two holder parts 105-1 and 105-2, the movable clamping elements 123 are first pressed outwards by means of the spring force, thereby releasing the clamping force (no compressed air) of the clamping elements. The holder part 105-2 is then rotated in order to achieve a stop, frictional and/or positive fit between the coupling openings 127 and the clamping elements 123. The geometry of the coupling openings 127 can be adapted for the positive fit. After coupling the two holder parts 105-1 and 105-2, the clamping force on the dental blank 103 can be maintained by means of compressed air via the pneumatic piston 113 via the clamping elements 123. A clamping device 125 for exerting a clamping force between the holder parts 105-1 and 105-2 is realized by the pneumatic pistons and their application with compressed air 131. In embodiment A, the clamping force is generated by compressed air.

In embodiment B, the clamping force is generated by spring force. In this case, the clamping force of the clamping elements 123 is released by means of compressed air so that the dental blank 103 can be clamped in the holder parts 105-1 and 105-2. After the compressed air is removed, the dental blank 123 is clamped without pressure by the spring force between the holder parts 105-1 and 105-2.

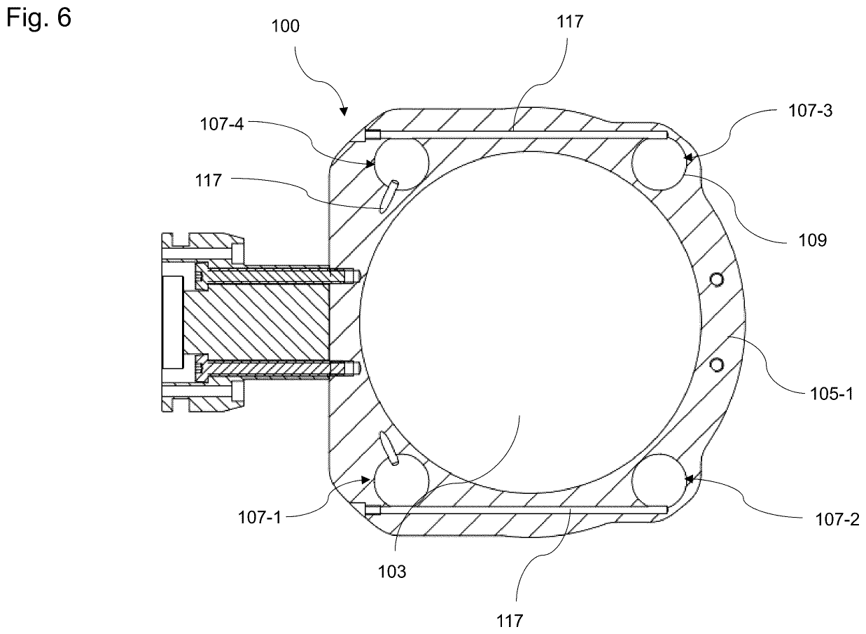

FIG. 6 shows a cross-sectional view of the clamping holder 100 for the dental blank 103 from above. The pneumatic elements 107-1, . . . , 107-4 are formed by four pneumatic cylinders 109, each with a pneumatic piston 113, which are arranged around the recess 115. The pneumatic cylinders 109 are connected to a common air duct 117, via which the compressed air can be introduced into the pneumatic cylinders 109 of the pneumatic elements 107-1, . . . , 107-4. The air duct 117 is arranged inside the lower holder part 105-1 or upper holder part 105-2.

Compressed air can also be applied to the pneumatic cylinders 109 by means of separate air ducts.

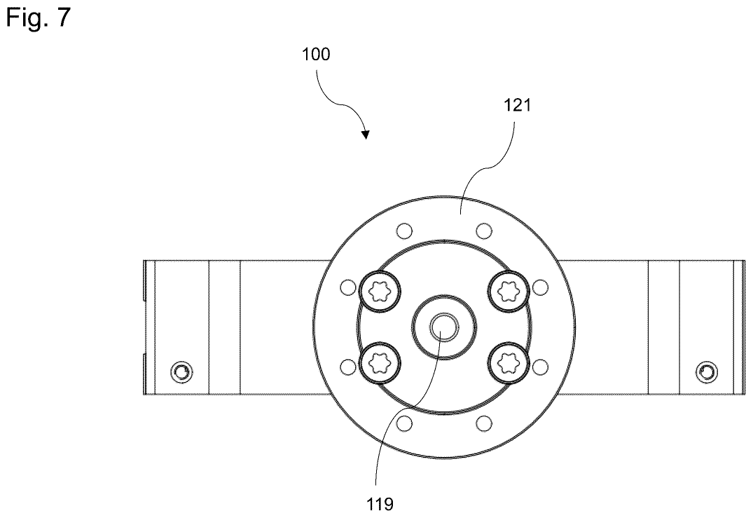

FIG. 7 shows a side view of the clamping holder 100 for the dental blank 103. The clamping holder 100 can also comprise a compressed air connection for an external supply of compressed air, so that the pneumatic elements 107-1, . . . , 107-4 can also be actuated by connecting an external compressed air supply when the clamping holder 100 is mounted in the processing machine. The first or second holder part 105-1 or 105-2 can be equipped with pneumatic elements 107-1, . . . , 107-4 and the compressed air can be supplied by means of a device.

In this case, a separate compressed air device or an external compressed air supply can be used before inserting the clamping holder 100 into the manufacturing device. This can also be used to actuate the clamping holder 100 outside the manufacturing device.

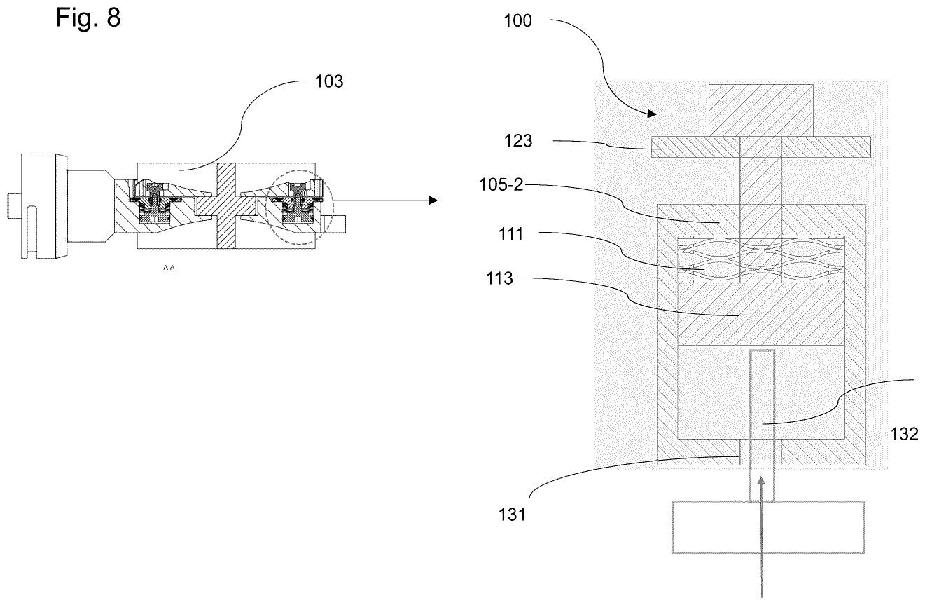

FIG. 8 shows a side view of the clamping holder 100 for the dental blank 103. The spring 111 above the piston 113 presses the clamping element 123 downwards, thus generating the clamping force which acts on the dental blank 103 between the first holder part 105-1 and the second holder part 105-2. By using a mechanical release device, such as a bolt device 135, which can be inserted through the opening 135 at the bottom and can act on the piston 113, the clamping force is released and the piston is pushed upwards. As a result, the holder part 105-1 can be released from the clamping element 123 and the dental blank can be removed. The mechanical release devices can also be integrated in the manufacturing device or arranged separately from the manufacturing device.

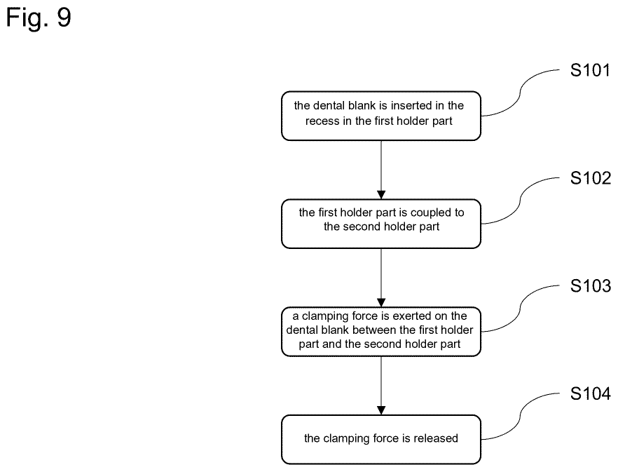

FIG. 9 shows a block diagram of a method of clamping the dental blank 103. In step S101, the dental blank is inserted into the recess 115 in the first holder part 105-1. Then, in step S102, the first holder part 105-1 is coupled to the second holder part 105-2 for the dental blank 103 by positively connecting the second holder part to the clamping elements 123 by a rotary movement as far as the stop. Here, the pressurized, pressure-released or pressureless clamping elements 123 are in an extended position.

By introducing force, discharging the compressed air from or introducing the compressed air into the pneumatic elements 107-1, . . . , 107-4, the clamping elements 123 are relieved or loaded and the clamping pins 123 are moved inwards. In step S103, the clamping force is exerted on the dental blank 103 between the first holder part 105-1 and the second holder part 105-2 by the springs 111 or the compressed air. As a result, the dental blank 103 is held without pressure or with pressure in the pneumatic elements 107-1, . . . , 107-4 in the clamping holder 100.

To release the upper holder part 105-2, the force or compressed air is again introduced into the pneumatic elements 107-1, . . . , 107-4 or discharged, so that the clamping force on the dental blank 103 is released and the clamping elements 123 are pressed outwards. The holder part 105-2 can then be released again from the holder part 105-1 by a rotary movement.

The clamping holder 100 enables dental blanks 103 to be clamped without tools using just one clamping device with optimum force distribution and reliability. The clamping holder 100 reduces the time required to change the dental blanks 103, as no tools are required. Only one clamping process is required for the dental blank 103 and the reliability of the holder for the dental blank is increased.

In addition, the handling of the clamping holder 100 is improved.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 clamping holder
103 dental blank
105 holder part
107 pneumatic element
109 pneumatic cylinder
111 spring
113 pneumatic piston/piston
115 recess
117 air duct
119 compressed air connection
121 interface
123 clamping element
125 clamping device
127 coupling openings
129 plate
131 compressed air
133 bottom
135 bolt device

1. A clamping holder for a dental blank, comprising:
a first holder part for inserting the dental blank;
a second holder part for the dental blank which is connected or can be coupled to the first holder part;
a clamping device for exerting a clamping force on the dental blank between the first holder part and the second holder part; and
a pneumatic element for releasing or generating the clamping force.

2. The clamping holder according to claim 1, wherein the clamping device comprises a spring.

3. The clamping holder according to claim 2, wherein the spring applies the clamping force to a pneumatic piston.

4. The clamping holder according to claim 3, wherein the pneumatic piston comprises a movable clamping element for coupling with the second holder part.

5. The clamping holder according to claim 1, wherein the pneumatic element is arranged inside the first or the second holder part.

6. The clamping holder according to claim 1, wherein the clamping holder comprises several pneumatic elements.

7. The clamping holder according to claim 6, wherein the pneumatic elements are distributed around a recess for inserting the dental blank.

8. The clamping holder according to claim 6, wherein the pneumatic elements are connected to one another by a common air duct.

9. The clamping holder according to claim 1, wherein the first holder part or the second holder part for the dental blank can be coupled to the second holder part or to the first holder part, respectively, by a rotary movement or a latching movement.

10. The clamping holder according to claim 1, wherein the clamping holder comprises a compressed air connection which is integrated in a mechanical interface for fastening the clamping holder to a processing machine, or a compressed air connection for an external supply of compressed air.

11. A clamping holder for a dental blank, comprising:
a first holder part for inserting the dental blank;
a second holder part for the dental blank which is connected or can be coupled to the first holder part;
a clamping device for exerting a clamping force on the dental blank between the first holder part and the second holder part; and
a release element for releasing the clamping force.

12. The clamping holder according to claim 11, wherein the clamping holder comprises several release elements for releasing the clamping force.

13. A method of clamping a dental blank, comprising the steps of:
inserting the dental blank into a first holder part;
coupling the first holder part with a second holder part for the dental blank;
exerting a clamping force on the dental blank between the first holder part and the second holder part; and
releasing the clamping force by a release element.

14. The method according to claim 13, wherein the dental blank is clamped between the first holder part and the second holder part by the clamping force or the compressed air is supplied to several pneumatic elements via a common air duct.

15. The method according to claim 13, wherein the release elements are actuated via an external device which is arranged outside a manufacturing device.
